(19) United States
(12) Patent Application Publication
(10) Pub. No.: US 2004/0026302 A1
(43) Pub. Date: Feb. 12, 2004

(54) Water filter assembly

(76) Inventor: Jack Lee, Chia Yi Hsien (TW)

Correspondence Address: Charles E. Baxley, Hart, Baxley, Daniels & Holton, Fifth Floor, 59 John Street, New York, NY, 10038, US

(21) Appl. No.: 10/216,684

(22) Filed: Aug. 12, 2002

(51) Int. Cl. B01D 24/12

(52) U.S. Cl. 210/94; 210/282; 210/287; 210/291; 210/449

(57) ABSTRACT

A water filtering assembly includes cup-shaped member and a top cover and a space is formed to receive any type of filtering agent which is convenient to be replaced. The cup-shaped member is made of transparent material so that the users may check the water filtering agent to replace with new filtering agent.

### FIELD OF THE INVENTION

The present invention relates to a water filter assembly which allows the user to fill with any type or shape of the filtering agent and a transparent window allows the user to see the filtering agent.

### BACKGROUND OF THE INVENTION

A conventional water filtering assembly is shown in FIG. 1 and generally-includes a first part 12 with a chamber defined therein and a fitting 121 for being engaged with a hose from which water enters. A second part 11 is threadedly connected to the first part 12 and a filtering agent 13 is received in the chamber in the first part 12. The second part 11 has a fitting 111 which is connected to water outlet part 15. Water passes through the water filtering agent 13 and goes out from the water outlet part 15, the water is filtered by the water filtering agent 13. The users have to memorize the date that the new water filtering agent 13 is put in the first part 12 and replaces it after a period of time according to the manufacturer's instruction. The shape of the water filtering agent 13 is fixed so that the users have to purchase it with certain shape and size.

The present invention intends to provide a water filtering assembly that has a cup-shaped member with a top cap and a bottom cap, the cup-shaped member can be filled with any shape or size of water filtering agent.

### SUMMARY OF THE INVENTION

In accordance with one aspect of the present invention, there is provided a buckle device for luggage and comprising

The primary object of the present invention is to provide a

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional water filtering assembly;

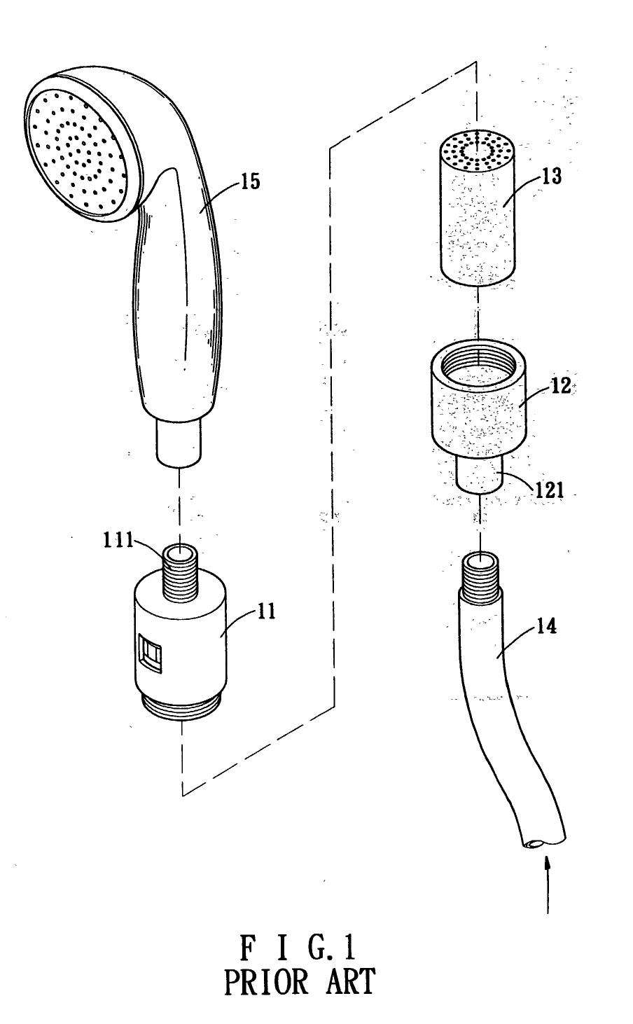

FIG. 2 is an exploded view to show the water filtering assembly of the present invention;

FIG. 3 is a cross sectional view to show the water filtering assembly of the present invention, and

FIG. 4 shows the water filtering assembly of the present invention is connected to a faucet.

### DETAILED DESCRIPTION OF THE PREFERRED EMBODIMENT

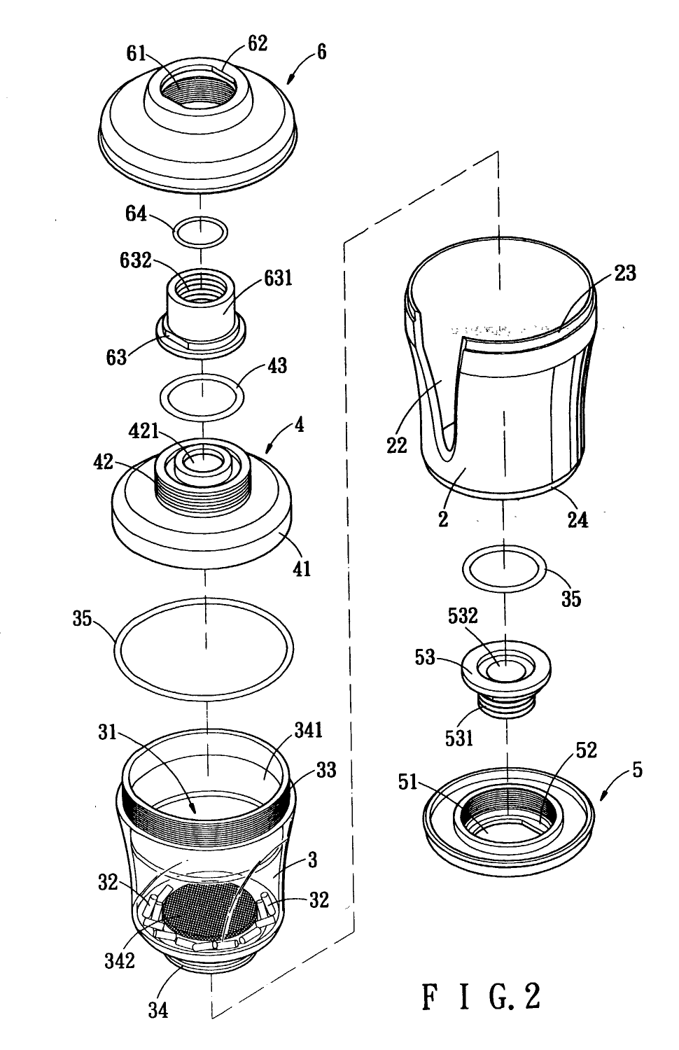

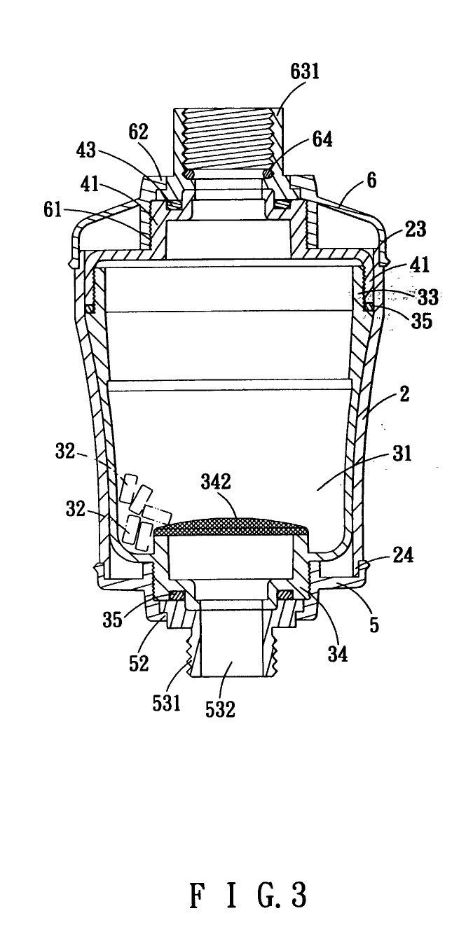

Referring to FIGS. 2 to 4, the water filtering assembly of the present invention comprises a cup-shaped member 3 having a space 31 therein for receiving water filtering agent 32 and a top annular connection portion 33 and a bottom annular connection portion 34 are respectively connected to a top and a bottom of the cup-shaped member 3. A filtering screen 342 is located at an opening of the bottom annular connection portion 34. The cup-shaped member 3 is made of transparent material.

A top cap 4 has an annular flange 42 on a top of the top cap 4 and a skirt portion 41 which is threadedly connected to the top annular connection portion 33 with a seal 35 located therebetween. A passage 421 is defined through the annular flange 42 and in communication with the space 31 in the cup-shaped member 3.

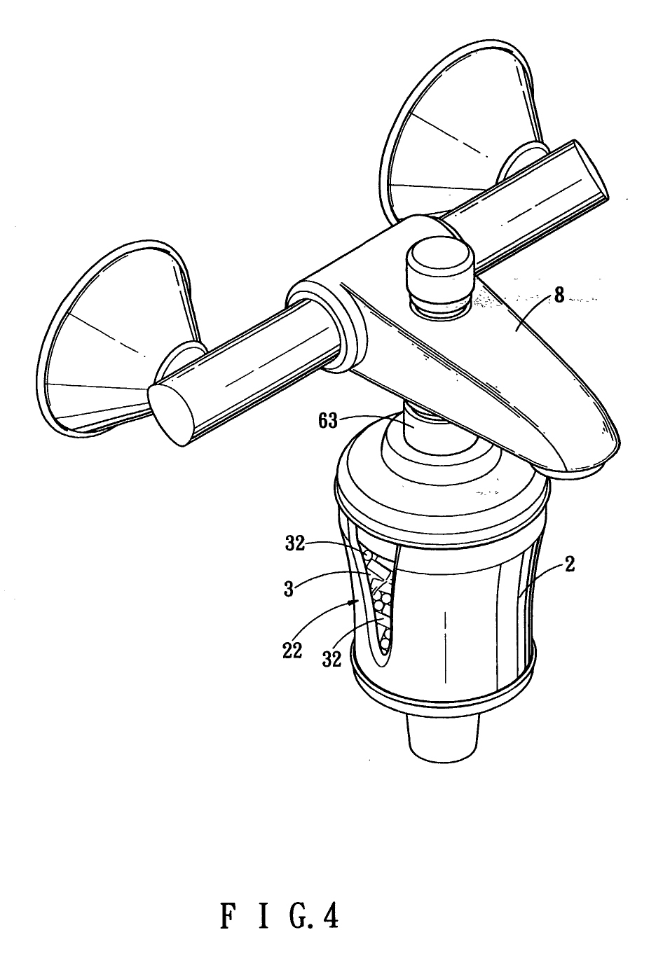

The cup-shaped member 3 is received in a container 2 that has various diameters and a recess 22 is defined n the container 2 so that the users may see the water filtering agent 32 via the recess 22 through the transparent cup-shaped member 3. A top shrunk engaging portion 23 and a bottom shrunk engaging portion 24 are connected to a top and a bottom of the container 2. A bottom cap 5 is threadedly connected to the bottom annular connection portion 34 of the cup-shaped member 3 and two stop flanges 52 extend inward from an inner periphery of a center hole 51 of the bottom cap 5. A first connection piece 53 is connected between the bottom annular connection portion 34 of the cup-shaped member 3 and the bottom cap 5. A shank 531 of the first connection piece 53 extends through the center hole 51 of the bottom cap 5 and the first connection piece 53 is stopped by the stop flanges 52 of the bottom cap 5. A through hole 532 is defined through the first connection piece 53. The bottom cap 5 is threadedly connected to the bottom annular connection portion 34 of the cup-shaped member 3. Referring to FIG. 4, an threaded outer periphery is defined in the shank 531 of the first connection piece 53 and the shank 531 is connected to a hose (not shown) which is connected to a source of water supply.

A top cover 6 is connected to the annular flange 42 of the top cap 4 with a seal 43 located therebetween. A second connection piece 63 with a through hole is connected between the annular flange 42 and the top cover 6. Two stop flanges 62 extend from an inner periphery of the center hole 61 of the top cover 6 so that the second connection piece 63 is limited by the stop flanges 62 of the top cover 6 which is secured to the top shrunk engaging portion 23 of the container 2. A threaded inner periphery 632 is defined in a shank 631 of the second connection piece 63 and a seal 64 is received in the shank 631 which is connected to a faucet 8 as shown in FIG. 4.

It is to be noted that the shank 531 and 631 may have threaded inner or outer periphery as needed, and wave-shaped threads (not shown) may also be employed in the shank 531/631 of the first and the second connection piece 53/63.

The disengagement of the parts of the assembly is easy and the water filtering agent can be seen by the users who may replace new filtering agent without any delay.

While we have shown and described the embodiment in accordance with the present invention, it should be clear to those skilled in the art that further embodiments may be made without departing from the scope of the present invention.

What is claimed is:

1. A water filtering assembly comprising:
a cup-shaped member having a space therein and a top annular connection portion and a bottom annular connection portion respectively connected to a top and a bottom of the cup-shaped member, a filtering screen located at an opening of the bottom annular connection portion and filtering agent filled in the cup-shaped member, and
a top cap having an annular flange on a top of the top cap and connected to the top annular connection portion, and-a passage in the annular flange being in communication with the space in the cup-shaped member.

2. The assembly as claimed in claim 1, wherein the cup-shaped member is made of transparent material.

3. The assembly as claimed in claim 1, wherein the cup-shaped member is received in a container that has various diameters and a recess is defined n the container, a top shrunk engaging portion and a bottom shrunk engaging portion connected to a top and a bottom of the container, a bottom cap connected to the bottom annular connection portion of the cup-shaped member, a first connection piece connected between the bottom annular connection portion of the cup-shaped member 3 and the bottom cap, a shank of the first connection piece being stopped by the bottom cap, the bottom cap connected to the bottom annular connection portion, a top cover connected to the annular flange of the top cap, a second connection piece connected between the annular flange and the top cover and a shank of the second connection piece being limited by the top cover, the top cover secured to the top shrunk engaging portion.

4. The assembly as claimed in claim 3 further comprising a threaded inner periphery defined in the shank of the second connection piece.

5. The assembly as claimed in claim 3 further comprising a threaded outer periphery defined in the shank of the first connection piece.

6. The assembly as claimed in claim 3 further comprising wave-shaped threads defined in the shank of the first and the second connection piece.
